(19) United States
(12) Patent Application Publication
(10) Pub. No.: US 2026/0140479 A1
(43) Pub. Date: May 21, 2026

(54) QUICK CORRECTION DEVICE WITH CONNECTING ROD FOR A HOROLOGY MOVEMENT

(71) Applicant: Montres Breguet S.A., L'Abbaye (CH)

(72) Inventor: Pascal FRIDERICI, L'Orient (CH)

(73) Assignee: Montres Breguet S.A., L'Abbaye (CH)

(21) Appl. No.: 19/357,284

(22) Filed: Oct. 14, 2025

(30) Foreign Application Priority Data
Nov. 19, 2024 (EP) 24214020.0

(51) Int. Cl. G04B 11/02; G04B 11/00; G04B 19/24; G04B 19/26

(52) U.S. Cl. CPC G04B 11/022; G04B 11/008; G04B 19/24; G04B 19/268

(57) ABSTRACT

A device (1) for correcting an indication provided by a display mechanism for a horology movement fitted with a display mechanism including an indicator wheel (2), the actuation of the indicator wheel (2) making it possible to change the display indication, the correction device (1) including a mobile articulation (10) including a connecting rod (3) that is mobile between two positions, a correction position in which the articulation (10) engages with the indicator wheel (2) to turn it, and a locked position in which the articulation (10) is moved away from the indicator wheel (2).

### CROSS-REFERENCE TO RELATED APPLICATIONS

This application claims priority to European Patent Application No. 24214020.0, filed on November 19, 2024, the entire contents of which are incorporated herein by reference.

### FIELD OF THE INVENTION

The invention relates to a quick correction device with a connecting rod for a horology movement comprising a display mechanism.

The invention also relates to a horology movement comprising such a correction device.

The invention relates to the field of horology, and more specifically to timepieces comprising a display mechanism.

### BACKGROUND OF THE INVENTION

This invention relates to watches that require a device for quickly correcting certain functions (date, day, month, or other), in particular display functions such as a date (simple, annual, perpetual, day/date, or other), or moon phase, tide, AM/PM displays, or other indicators. A particular example of an annual date mechanism is described in patent EP1666991B1 held by ETA SA.

To correct the month, the user usually has to make the correction via the date. In the worst cases, this can be a long and tedious process. It may be necessary to make a thirty-day correction. Similarly, if the user makes a mistake during the correction, the operation has to be repeated. Using the date correction device could lead to excessive use and potentially cause malfunctions.

To actuate an indicator wheel, correction devices often have levers, which are essential components in horology mechanisms that enable a mechanism to be switched between several different modes, usually between two specific positions. One of the positions actuates the rotation of the indicator wheel. A horology lever is often accompanied by a return spring to ensure that the movement is correctly transmitted or positioned, as the case may be.

The correction device generally consists of a train consisting of one or several components and actuated from the winding stem.

However, such a correction device takes up space in the movement and often requires numerous components, particularly when the indicator wheel is away from the winding stem.

A common alternative is to use buttons incorporated into the watchcase. However, this alternative is often relatively expensive and can cause problems with the water-resistance of the watchcase.

### SUMMARY OF THE INVENTION

The present invention aims to remedy the aforementioned drawbacks of the prior art and to enable the user to make a quick correction to a display mechanism, and more specifically to a date mechanism.

To this end, the invention relates to a device for correcting an indication provided by a display mechanism for a horology movement fitted with a display mechanism comprising an indicator wheel with a pipe, the actuation of the indicator wheel making it possible to change the display indication.

The correction device is remarkable in that it comprises an articulation that is mobile around a pivot, the articulation being fitted with a connecting rod that is mobile between two positions, a correction position in which the articulation engages with the indicator wheel to turn it step by step, and a locked position in which the articulation is moved away from the indicator wheel.

This correction device therefore offers a new type of architecture with innovative components, particularly the use of a connecting rod.

The invention ensures that the correction device takes up less space and is easier to incorporate into a horology movement, as it comprises fewer components while functioning efficiently.

According to a particular embodiment of the invention, the articulation comprises a click rotationally fitted to a first end of the connecting rod.

According to a particular embodiment of the invention, the click is also mobile around a pivot.

According to a particular embodiment of the invention, the click comprises a beak configured to be at least partially inserted into the toothing on the indicator wheel so as to turn it when the articulation is in the correction position.

According to a particular embodiment of the invention, the correction device comprises a cam mobile for engaging the connecting rod so as to push it from the locked position to the correction position when the cam mobile is actuated.

According to a particular embodiment of the invention, the cam mobile has teeth configured to come into contact with a beak arranged at a second end of the connecting rod.

According to a particular embodiment of the invention, the correction device comprises a jumper spring exerting a return force on the connecting rod to return it from the correction position to the locked position.

According to a particular embodiment of the invention, the correction device comprises a jumper for positioning the indicator wheel and keeping it from turning in the event of shocks, when it is not actuated by the mobile articulation, the jumper being designed to be inserted into the toothing on the indicator wheel to position it.

According to a particular embodiment of the invention, the correction device comprises a connecting rod spring exerting a return force on the connecting rod and the click to keep them away from the indicator wheel, in the locked position.

According to a particular embodiment of the invention, the correction device extends substantially in the same plane.

According to a particular embodiment of the invention, the display mechanism is a moon phase display or a date display or a day display or a month display or a tide display or a time zone display.

The invention also relates to a horology movement comprising such a correction device.

### BRIEF DESCRIPTION OF THE DRAWINGS

Other characteristics and advantages of the invention will become apparent from the detailed description below, with reference to the accompanying drawings, in which:

FIG. 1 shows a schematic perspective view of an embodiment of a correction device according to the invention,

FIG. 2 shows a schematic view of the underside of the correction device shown in FIG. 1,

FIG. 3 shows a schematic view of the top of the correction device in FIG. 1, when the articulation is in the locked position away from the indicator wheel,

FIG. 4 shows a schematic view of the top of the correction device in FIG. 1, when the articulation is in the correction position engaging with the indicator wheel, and

FIG. 5 shows part of a horology movement comprising the correction device.

### DETAILED DESCRIPTION OF PREFERRED EMBODIMENTS

The invention relates to the field of horology mechanisms, and more specifically to movement control and transmission mechanisms. It is preferentially applied to the correction and updating of display mechanisms in a horology movement in a timepiece.

The invention relates more specifically to a device 1 for correcting an indication provided by a display mechanism in a horology movement. Preferably, the correction device 1 extends substantially in the same plane.

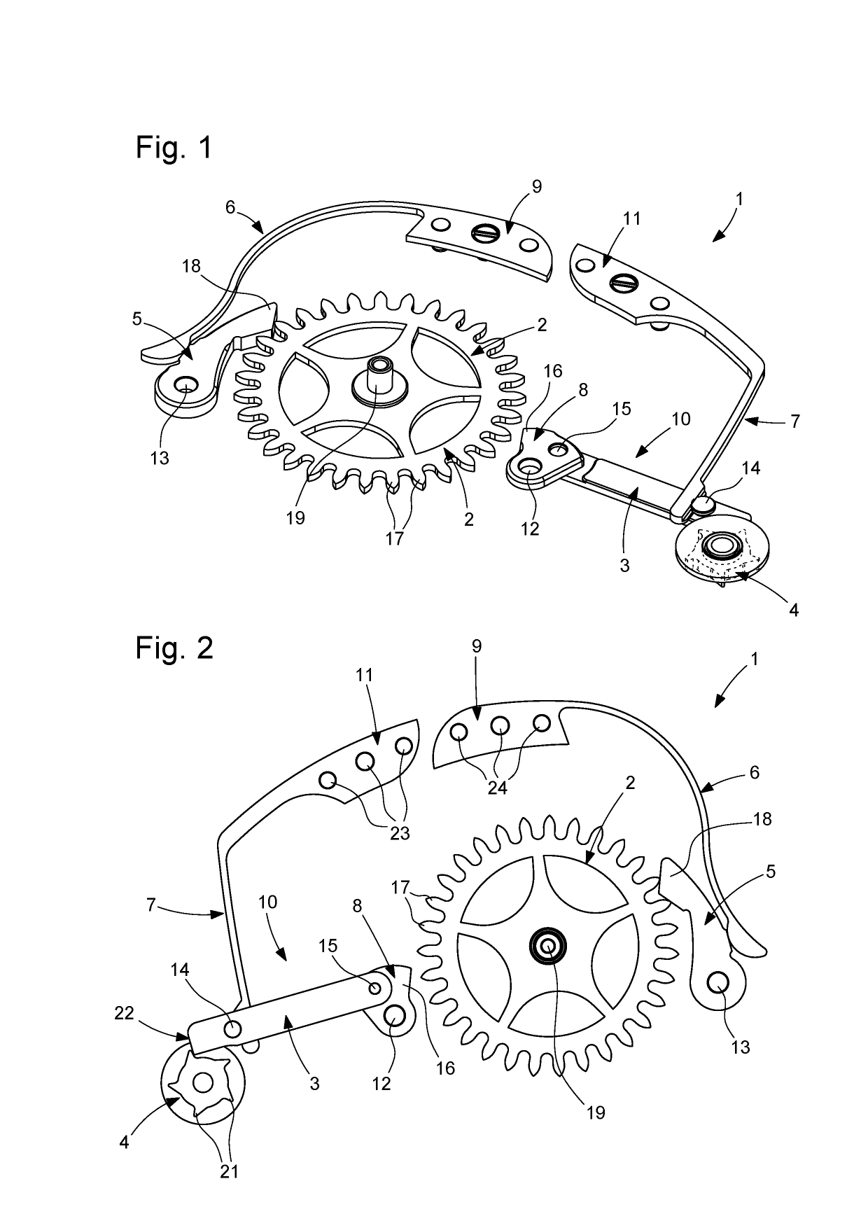

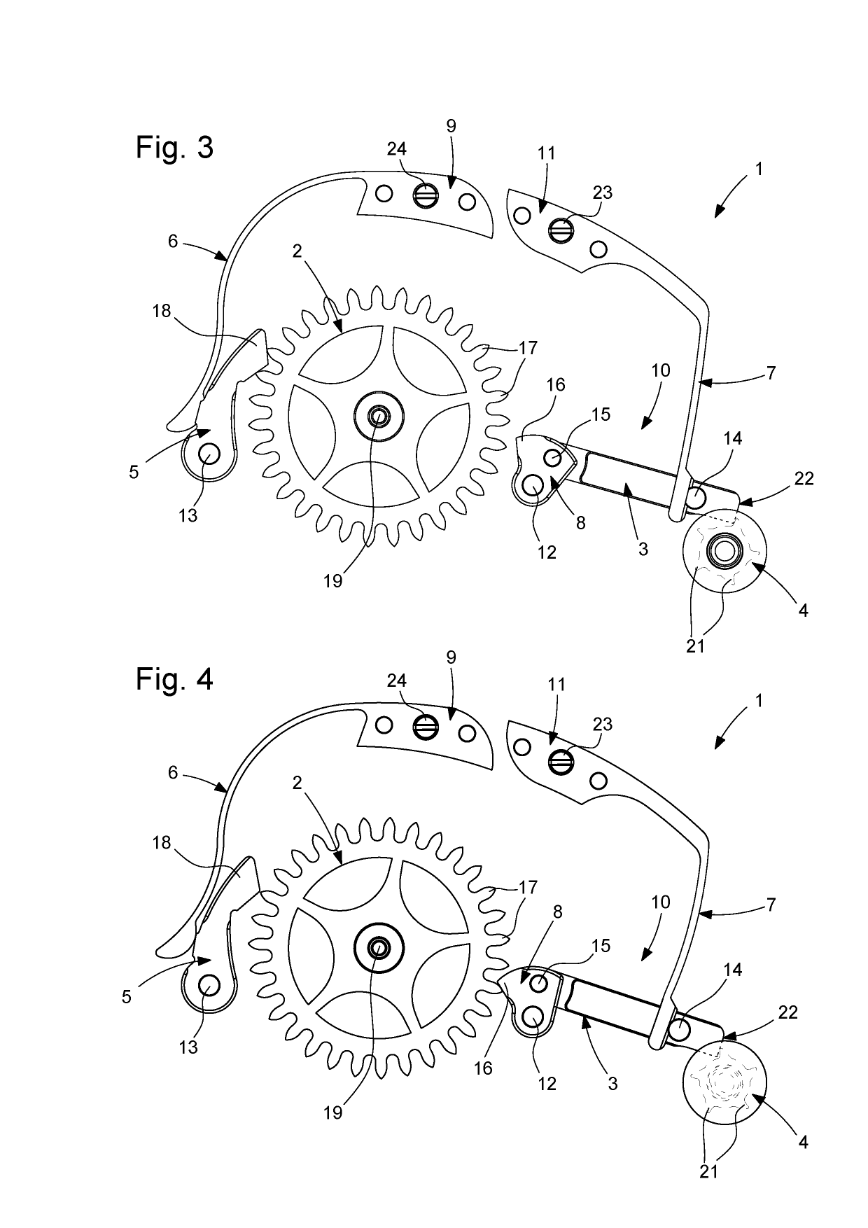

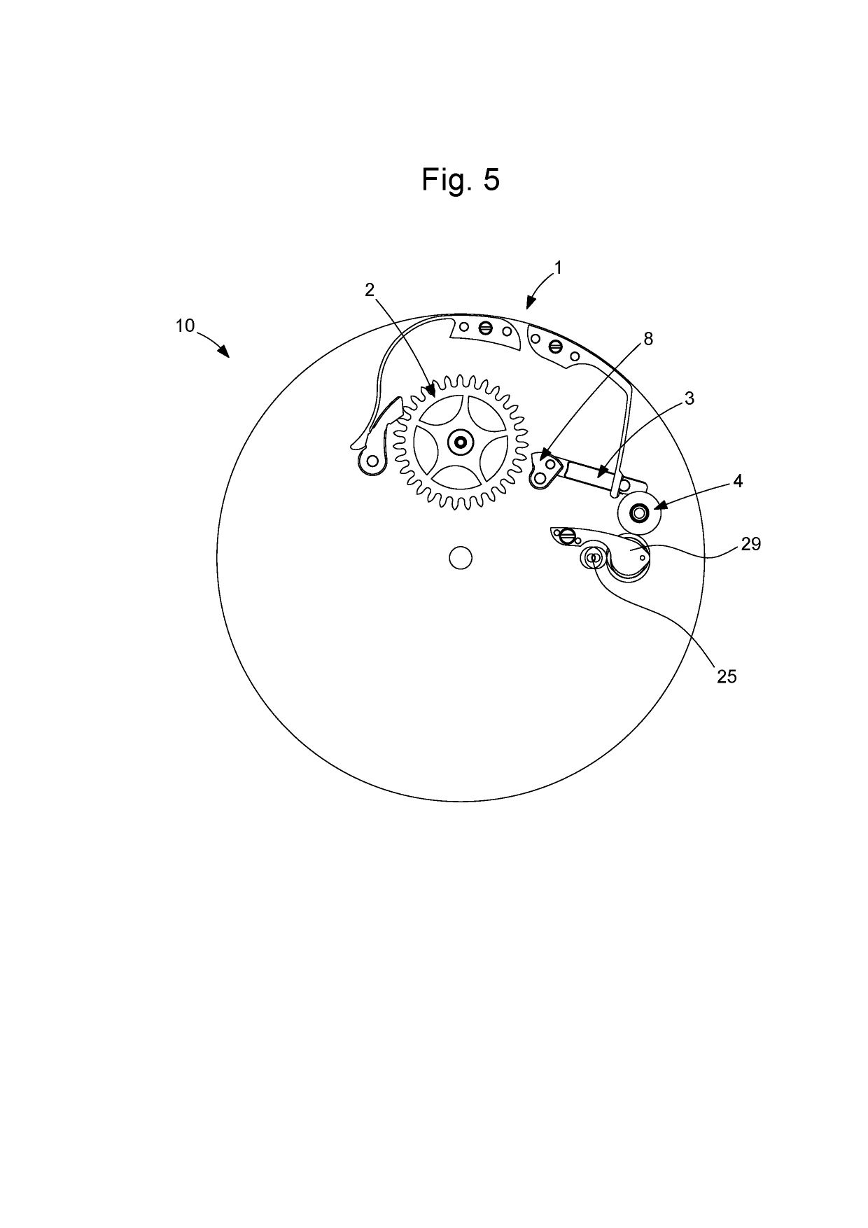

In FIGS. 1 to 4, the display mechanism comprises an indicator wheel 2 with a pipe 19. A hand, not shown in the figures, is fitted on the pipe 19 to display a date, for example. The indicator wheel 2 comprises peripheral toothing 17 enabling the indicator wheel 2 to be turned.

The indicator wheel 2 is mechanically joined to the hand, and the display indication can be changed by actuating the indicator wheel 2.

Preferably, the change is made step by step. Thus, for each rotation of the indicator wheel 2 by one notch, the display is changed by one unit.

The correction device 1 comprises a jumper 18 to position the indicator wheel 2 when it is not actuated and to keep it from turning in the event of shocks.

The jumper 5 is inclined 18 at a first end and is rotationally fitted around a pivot arranged at a second end of the jumper 5. The pivot is formed, for example, by a blom stud, a pin or a shouldered screw. The jumper 5 comprises a hole 13 for the pivot.

The correction device 1 comprises a jumper spring 6 arranged to hold the jumper 5 against the indicator wheel 2. In this example, the jumper spring 6 is a curved blade with a first end pressing against the jumper 5 to push it against the indicator wheel 2. A second end of the blade is joined to a heel 9 that has fastenings 24 so that it can be fitted to a plate or a bar on the horology movement, in particular by one or more blom studs and/or one or more screws.

To actuate the indicator wheel 2, the correction device 1 comprises a mobile articulation 10 for engaging with the indicator wheel 2 to turn it.

According to the invention, the articulation 10 comprises a connecting rod 3 that is mobile between two positions, a correction position in which the articulation 10 engages with the indicator wheel 2 to turn it, and a locked position in which the articulation 10 is moved away from the indicator wheel 2.

In the locked position, the articulation 10 cannot rotate the indicator wheel 2 and the wheel does not turn.

In this example, the connecting rod 3 comprises an elongated body, for example rectangular, fitted with two blom studs 14, 15 arranged on one face of the connecting rod 3, one at each end.

The articulation 10 comprises a click 8 rotationally fitted on the blom stud 15 at the first end of the connecting rod 3, so that it can turn around the blom stud 15.

The click 8 is also rotationally fitted around a pivot, preferably fixed relative to the movement plate. To this end, the click 8 comprises two holes, a first hole for the blom stud 15, and a second hole 12 for a pivot around which the click 8 can turn. The pivot is formed, for example, by a blom stud or a shouldered screw inserted into the second hole 12.

The click 8 also comprises a beak 16 that can be inserted into the toothing 17 on the indicator wheel 2 to turn it. The beak is turned towards the indicator wheel 2.

When the connecting rod 3 moves from the locked position to the correction position, the connecting rod 3 moves in a substantially linear motion or even in a straight line. The click 8 is pushed by the connecting rod 3 and turns around both the blom stud 15 on the connecting rod 3 and around the pivot, which is preferably fixed relative to the horology movement. The beak 16 on the click 8 is thus lowered to engage with the toothing 17 on the indicator wheel 2 to turn it when the connecting rod 3 is in the correction position.

To move the connecting rod 3, the correction device 1 comprises a cam mobile 4 engaging with the connecting rod 3, so as to push it from the locked position to the correction position when the cam mobile 4 is actuated. The cam mobile 4 is fitted with teeth 21 configured so as to be able to come into contact with a beak 22 arranged at a second end of the connecting rod 3. The cam mobile 4 (doesn't this imply an assembly?) is rotationally arranged at the rear of the connecting rod 3.

The correction device 1 comprises a connecting rod spring 7 exerting a return force on the connecting rod 10 to return the connecting rod 3 from the correction position to the locked position. The connecting rod spring 7 also comprises a flexible curved blade joined at one end to a second heel 11 and presses against the blom stud 14 on the inside of the connecting rod 3 to push the connecting rod 10 towards its second locked position. The second heel 11 comprises fastenings 23 for assembling the second heel 11 to the movement.

The blom stud 14 can also be used to guide the connecting rod 3, the blom stud 14 being mobile, for example, in a slot in an additional plate not shown in the figures.

For example, the correction device 1 is incorporated into a horology movement 10 so as to correct a date display. The correction is made by the user using a winding stem, not shown in the figures.

A longitudinal movement of the winding stem directly or indirectly causes an intermediate correction wheel 25 to move into a specific position (generally the intermediate position in a three-position mechanism), which meshes with a sliding pinion assembly 29 to actuate the cam mobile 4.

Turning the winding stem clockwise causes the intermediate correction wheel 25 to turn counterclockwise, the sliding pinion assembly 29 to turn clockwise and the cam mobile 4 to turn counterclockwise. The cam mobile 4 thus actuates the movement of the connecting rod 3 and of the click 8 against the indicator wheel 2 according to the method described above. The indicator wheel 2 is thus corrected in steps every time a tooth on the cam mobile pushes the connecting rod 3.

Of course, the correction device according to the invention is not limited to the embodiments described above and various simple modifications and variants can be considered by the person skilled in the art without departing from the scope of the invention as defined by the appended claims.

1. A device (1) for correcting an indication provided by a display mechanism for a horology movement fitted with a display mechanism comprising an indicator wheel (2), the actuation of the indicator wheel (2) making it possible to change the display indication, the correction device (1) comprising a mobile articulation (10), wherein the articulation (10) comprises a connecting rod (3) that is mobile between two positions, a correction position in which the articulation (10) engages with the indicator wheel (2) to turn it, and a locked position in which the articulation (10) is moved away from the indicator wheel (2).

2. The correction device according to claim 1, wherein the articulation (10) comprises a click (8) rotationally fitted to a first end of the connecting rod (3).

3. The correction device according to claim 2, wherein the click (8) is also mobile (10) around a pivot (12).

4. The correction device according to claim 2, wherein the click (8) comprises a beak (16) configured to be at least partially inserted into the toothing (17) on the indicator wheel (2) so as to turn it when the articulation (10) is in the correction position.

5. The correction device according to claim 1, further comprising a cam mobile (4) for engaging the connecting rod (3) so as to push it from the locked position to the correction position when the cam mobile (4) is actuated.

6. The correction device according to claim 5, wherein the cam mobile (4) has teeth (21) configured to come into contact with a beak (22) arranged at a second end of the connecting rod (3).

7. The correction device according to claim 2, further comprising a connecting rod spring (7) exerting a return force on the connecting rod (3) to return it from the correction position to the locked position.

8. The correction device according to claim 1, further comprising a jumper (5) for positioning the indicator wheel (2) and keeping it from turning in the event of shocks, when it is not actuated by the mobile articulation (10), the jumper (5) being designed to be inserted into the toothing (17) on the indicator wheel (2) in order to lock it.

9. The correction device according to claim 8, further comprising a jumper spring (6) exerting a return force on the jumper (5) to hold it against the indicator wheel (2).

10. The correction device according to claim 1, wherein the correction device extends substantially in the same plane.

11. The correction device according to claim 1, wherein the display mechanism is a moon phase display or a date display or a day display or a month display or a tide display or a time zone display.

12. A horology movement comprising the device for correcting an indication provided by the display mechanism according to claim 1.
